(19) United States
(12) Patent Application Publication
(10) Pub. No.: US 2026/0301395 A1
(43) Pub. Date: Oct. 1, 2026

(54) VISION FOUNDATION MODEL AND METHOD

(71) Applicant: Sony Group Corporation, Tokyo (JP)

(72) Inventors: Lingjuan LYU, Schlieren (CH); Weiming ZHUANG, Singapore (SG); Zhizhong LI, Schlieren (CH); Chen CHEN, Schlieren (CH); Sina SAJADMANESH, Schlieren (CH); Jingtao LI, Tempe, AZ (US); Jiabo HUANG, Shenzhen (CN); Vivek SHARMA, Karlsruhe (DE); Peter H. STONE, Austin, TX (US); Michael S. SPRANGER, Tokyo (JP)

(73) Assignee: Sony Group Corporation, Tokyo (JP)

(21) Appl. No.: 19/095,939

(22) Filed: Mar. 31, 2025

(51) Int. Cl. G06V 10/82; G06V 10/96

(52) U.S. Cl. CPC G06V 10/82; G06V 10/96

(57) ABSTRACT

Circuitry comprising a vision foundation model comprises a backbone, comprising a frozen pre-trained vision transformer ‘ViT’, and a trainable adapter configured to interact with tokens of the ViT for successive blocks of the ViT, by use of an injector and extractor; the trainable adapter is configured to generate an output for the backbone for passing as input to a decoder, and the trainable adapter is trained in conjunction with training a plurality of different decoders comprising a first set of decoders, respectively coupled to the backbone for respective tasks, to produce the completed vision foundation model based on multi-task learning.

### BACKGROUND OF THE INVENTION

### Field of the Invention

The present invention relates to a vision foundation model and method.

### Description of the Prior Art

Foundation models are general purpose large scale artificial intelligence models that can subsequently be used for more specialised applications. A well-known example for text is the large language model ‘LLM’ called Chat-GPT. Such systems use a transformer (an attention mechanism) to focus on key aspects of a text string.

Meanwhile vision foundation models ‘VFMs’ similarly are trained on general recognition tasks before being used for a specific application, and well known examples include Florence, InternImage, and BEiT.

However, these systems require very large initial training sets (e.g. Florence is pre-trained on 900 million curated image-text pairs), and the resulting large model can also require significant specialized additional training to perform a specific object detection task.

This results in a VFM that is computationally expensive to train, re-train, and then run for inference tasks. This problem is especially acute when the VFM might preferably be embedded in computationally restrictive devices such as internet of things ‘IoT’ devices to locally pre-process images, in order to reduce upload bandwidth for such tasks at a remote server and improve local functionality. Hence the larger/more complex the VFM, the greater the associated processing and power costs, and the less flexible the IoT applications.

The present invention seeks to address or mitigate this problem.

### SUMMARY OF THE INVENTION

Various aspects and features of the present invention are defined in the appended claims and within the text of the accompanying description.

In a first aspect, a vision foundation model is provided in accordance with claim 1.

In another aspect, a vision application is provided in accordance with claim 11.

In another aspect, a device is provided in accordance with claim 13.

In another aspect, a method of generating a vision foundation model is provided in accordance with claim 14.

In another aspect, a server is provided in accordance with claim 17.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a schematic diagram of a vision foundation model during a first training stage, in accordance with embodiments of the present description.

FIG. 1B is a schematic diagram of a vision foundation model during a second training stage, in accordance with embodiments of the present description.

FIG. 2A is a schematic diagram of a vision foundation model in accordance with embodiments of the present description.

FIG. 2B is a schematic diagram of a visual transformer block in accordance with embodiments of the present description.

FIG. 3 is a flow diagram of a method of generating a vision foundation model in accordance with embodiments of the present description.

### DESCRIPTION OF THE EMBODIMENTS

A vision foundation model and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

### Vision Foundation Models

Computer vision models traditionally use convolutional neural networks ‘CNNs’ to extract significant features from images. CNNs operate directly on pixel-level data, exploiting spatial hierarchies and local patterns, and the CNNs process different portions of the image in turn. Such models and/or the component parts thereof may be structured machine interpretable data or code. In some embodiments, such models may be packaged as executable code.

Recently, the transformer attention mechanism used by LLMs like Chat-GPT has also been applied to computer vision to create a vision transformer ‘ViT’. A ViT treats an image as sequences of patches, corresponding how an LLM treats words as a sequence of tokens—and indeed the internal representation of a ViT may be referred to as using such tokens. Using this representation and the self-attention process of the transformer, a ViT can learn complex patterns and relationships within images.

In brief, an image is split into equally sized tiles or patches, which are then flattened to each form a vector that can be treated as sequential data (similarly to a text sequence). These vectors typically then undergo a dimensional reduction whilst retaining important features. Data indicating the original positions of the image tiles/patches now represented by the reduced vectors is provided with these reduced vectors so that the ViT can understand their spatial relationships when they are provided to the ViT in a similar manner to a sequence of tokens in an LLM. Finally any supplementary representational data such as a classification token may also included, typically at the start of the sequence.

The ViT typically includes a number of components such as a multi-head self-attention mechanism that determines attention weights to prioritise vectors in the sequence, and also multilayer perceptrons (MLPs) to perform subsequent data transformations.

The self-attention mechanism learns to identify the importance of different parts of an input image to different parts of the model's learned representations (e.g. how relevant bits of the image are to a current task). This may take the form of a set or grid of heatmaps, where each such map represents the attention weights between a token and other tokens (whether patches or text/labels). Hence for example there will be a high attention value for the patch of an image containing a basketball and text/labelling for a basketball.

The MLPs are typically a series of transformation layers applied to the output of the self-attention mechanism, thereby performing more conventional machine learning processing on the parts of the input considered important to the task(s) being learned.

The output of the ViT may be for example a modified classification token, indicating the content of the original image. Other examples may include data relevant to image segmentation for an important aspect of the input image, tokens relevant to a textual description of the image, or tokens that enable the construction of a new or modified image.

In some variants, the inputs are generated by a CNN pre-processing stage rather than from flattened and reduced tiles of the image. This can be beneficial as the CNN output typically encodes spatial relationships within itself.

In any event, as a consequence of the transformer approach, ViT models can in principle learn generic feature representations in an unsupervised fashion, without labels for the training data.

As noted previously, such generic models are then fine-tuned to a specific task. For example the VFM known as ‘Florence’ can be further tuned using a large-scale detection dataset (FLOD-9M) to obtain a specialized model to perform an object detection task.

### Compact VFM

In embodiments of the present description, a compact and hence also more efficient vision foundation model is provided.

The VFM can support a variety of computer vision tasks whilst having a comparatively small number of parameters (for example in the order of 100 million). Notably however, only a small subset of these need to be trained for such tasks.

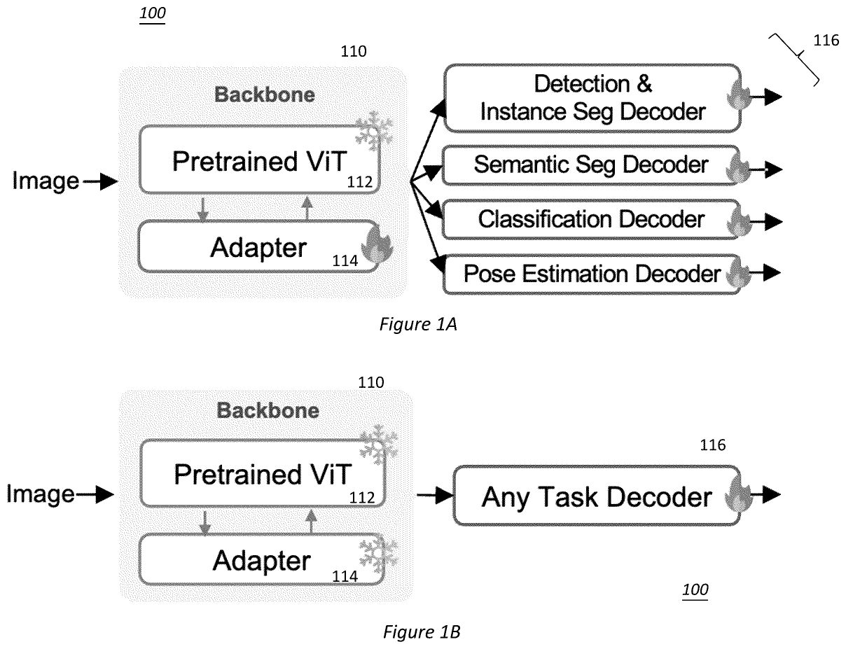

This is achieved by use of a new architecture, as shown in FIG. 1A, in which the VFM 100 features a backbone 110 comprising a pre-trained ViT 112 and a parallel adapter 114, in conjunction with a suite of task-specific decoders 116. In these figures, the parameters of an AI are indicated as frozen/locked by a snowflake symbol, whilst parameters that are adjustable are indicated by a flame symbol.

In addition to comprising a pre-trained ViT, the VFM itself is trained using a further two-stage process (although the second stage is optional).

### Stage 1—Multitask Training

In this first stage, the VFM is pre-trained on a core set of vision tasks. These may be any suitable tasks, but typically enable further vision processing. Hence typically the tasks comprise image-level, region-level, and pixel-level perception. As noted elsewhere herein, such vision tasks may also encompass a range of modalities including classification/recognition, image generation, and captioning/labelling. As noted above, this training is in the context of system that uses a shared backbone and multiple task-specific decoders each for a respective vision task.

The training typically comprises ongoing training of the adapter whilst individual decoders are swapped in and out on a regular basis; consequently the training (e.g. with regards to the targets relating to a given decoder) changes for the adapter on a regular basis, whist for the decoders training is typically cumulative over multiple sessions, with the adapter having changed (been subject to training with other decoders) in the meantime. The scheduling and ordering of such mixed learning may be chosen empirically.

Because the adapter is able to use the strong representations from the pre-trained and fixed ViT (as a non-limiting example, DINOv2), the adapter can be efficiently trained in the backbone.

The adapter itself comprises relatively few weights/parameters. In an example coupled with DINOv2, the adapter comprises just 13.6% of the total parameters of the backbone. This can be seen as a representative proportion, with possible values ranging from less (for example 5%) to more (for example 30%), but in any event being a minority of the total parameters in the backbone.

This significantly reduces the training load, not just in terms of not having to train the backbone from scratch, but also in terms of training just the smaller adapter in response to a well-trained ViT.

The adapter is trained to inject task-specific visual knowledge missing in the pre-trained ViT, as described elsewhere herein, and learns a unified representation that supports diverse tasks by different decoders through multitask training.

It will be appreciated that the VFM generates a representation of the sequence of image patches (e.g. in the form of tokens), and given that encoded representation of the image, a given decoder can for example perform image classification based on the representation, or generate a new sequence of image patches or text for example to modify the image or create a caption for it, depending on the task.

Multitask training provides the VFM, through mutual training of the adapter and multiple decoders for different tasks in the context of a fixed ViT, the ability to generate a common or general representation of the image that provides the information needed for each of the decoders to function.

Having a good range of decoders at this stage (for example a decoder for a classification task, a decoder for an image output task, and a decoder for a text output task, and/or covering image, region, and pixel-level perception) can help to provide such a suitable generalized output that will also be of use for future as yet unseen specific tasks, such as for example face recognition, transcribing car number plates, or reading machine readable content and similar structured representations of data such as QR codes or calibration markers for images or sensing apparatus.

### Stage 2—Task-Specific Adaptation

The second stage is optional in that if the decoders trained in the first stage provide all the functionality that is desired, then no further training is required.

In any event, referring now to FIG. 1B, for the second stage both the ViT and the now trained adapter of the backbone are frozen/locked. However, because the adapter was trained together with a variety of decoders, thereby developing a generalised representation amenable to work with decoders implementing different tasks, the frozen backbone outputs data that is amenable to training new decoders on new tasks (as well as using the previously trained decoders, or refining their training further).

By only training or fine tuning new (or existing) decoders whilst the backbone is frozen, typically for all subsequent new tasks, this allows the VFM to progressively expand capabilities with new decoders for new tasks, whilst having a relatively low training cost as only the respective decoder is trained. Notably, as the backbone is frozen, the expansion to new capabilities with new decoders does not affect the performance or behaviour of the system for existing decoders, which would be the case if some or all of the backbone was also re-trained to accommodate new tasks. This improves system reliability, portability, and scalability.

Hence more generally, by using a pre-trained and fixed ViT, an adapter can be trained to work with a suite of task-based decoders to provide task-specific visual knowledge to/for the ViT, in a manner that is generalized due to training with multiple tasks for multiple decoders. As a result when the adapter is also fixed so that the backbone is frozen, new decoders can be trained for new tasks without disrupting the performance of the backbone with other decoders.

In other words, the adapter learns to cooperate with the pre-trained ViT to provide a modular VFM in which new decoders are trained to implement new tasks, e.g. by training the adapter to provide this capability whilst training a suite of decoders on a set of core tasks.

### Backbone Architecture

This combination of a vision transformer with an adapter utilises a new architecture.

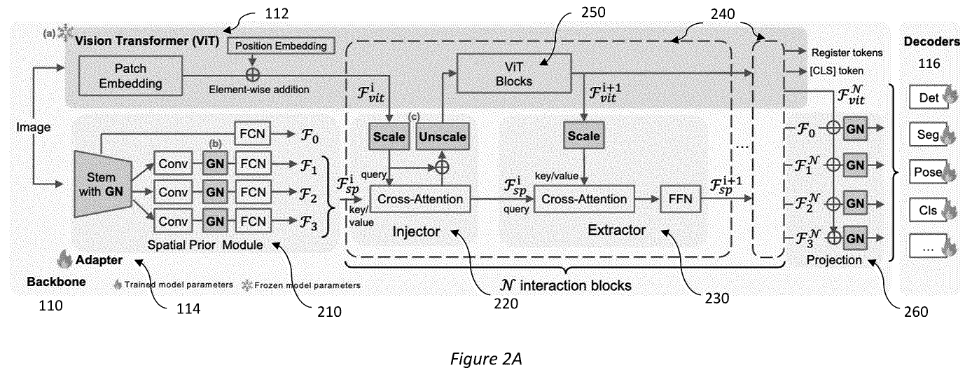

Referring now to FIG. 2A, as described elsewhere herein the backbone 100 is shared with all the tasks, while each task has its own decoder 116. The backbone consists of a ViT 112 initialized with pre-trained weights (as a non-limiting example, DINOv2), and a randomly initialized adapter 114 (or potentially a partially trained adapter trained with the same ViT on a similar or partially overlapping set of tasks, where this would beneficially shorten the training process).

The adapter is designed to facilitate multi task learning, and comprises a spatial prior module 210 for spatial feature extraction ‘SPM’ to introduce multi-scale features for vision tasks.

There are then N interaction blocks 240, denoted in FIG. 2A by the dashed lines; one interaction block is expanded to show the details typically present in each one.

In each interaction block, an injector 220 of the adapter is configured for interacting with or modifying data passing through the ViT to the first of one or more ViT processing blocks 250, and an extractor 230 of the adapter is configured for interacting with or modifying data passing out of the last ViT processing block.

Referring to FIG. 2B, the or each ViT processing block in an interaction block is typically a standard transformer encoder block such as are found for example in DINOv2, typically comprising a multi-head attention mechanism and one or more multilayer perceptrons, optionally together with normalization layers.

Meanwhile, the injection block of the adapter comprises an attention mechanism, similar to that of the ViT block, that integrates or injects spatial feature information obtained from the spatial prior module. The extractor module similarly comprises an attention mechanism.

Outputs from the last ViT block and the extractor of an interaction block, after any optional final processing, are passed as inputs to the next interaction block, and so on. The number of interaction blocks may vary according to model size.

Outputs from the last interaction block are then passed to a projection module 260 for final feature aggregation and normalization. The outputs of the projection module then form the basis of the inputs to the respective decoders.

Notably within this Architecture:

i. As mentioned elsewhere herein the ViT is frozen (e.g. all the parameters in the multi-head attention mechanisms and multilayer perceptrons are fixed with no further training), in contrast to the conventional approach of training all ViT parameters in conjunction with serial components such as decoders or parallel components such as (in the present case) the adapter.

This approach speeds up convergence and improves generalization for the elements of the VFM that are trained in stage 1 (the adapter and decoders). It also prevents catastrophic forgetting (the loss of previously learned knowledge) or more generally a change in performance/behavior when different decoders are swapped in and out, because the performance of the ViT itself is protected.

It will also be appreciated that because the adapter is small compared to the ViT (13.6% of the backbone weights in the example herein), this makes training less computationally expensive and hence faster.

ii. The adapter optionally uses group normalization GN rather than batch normalization BN (see GN blocks in FIG. 2A). With BN different tasks share the same set of BN statistics during inference, but for multitask learning this is less effective as some statistics will conflict for different tasks. By optionally replacing some or preferably all the BN layers with GN layers, performance can be improved across typically all tasks when using multitask learning.

iii. The token norms in ViT increase progressively after each set of ViT blocks and/or per interaction block, and so the adapter must interact with tokens of varying norm scales. To enable interaction with each ViT layer, the ViT tokens for the current image are scaled before interaction with the injector (i.e. as they are passed from the ViT to the adapter) to a consistent scale in the adapter. The scale factor may be for example:

$$\sqrt{d} / \overline{{‖ x ‖}_{2}}$$

Where d is the feature dimension of the tokens, and ∥x∥₂ is the average L2 norm of the tokens.

Then after processing in the injector module, they are reverted to their current scale in the ViT (see the scale and unscale blocks of the injector in FIG. 2A).

Similarly after passing through the ViT blocks, the tokens are scaled to a consistent scale when passed to the extractor (see the scale block of the extractor in FIG. 2A), e.g. using the same approach to calculating the scale factor.

Ensuring that the tokens used by the adapter have a stable norm assists with the training speed, convergence, and generalization performance of the adapter.

It will be appreciated that the specific architecture shown in FIGS. 2A and 2B, and described herein is for the purposes of explanation, and is not limiting on either the ViT or the adapter.

More generally, in stage 1 the architecture comprises a pre-trained and fixed ViT and a trainable adapter that interacts with token data before and after ViT processing blocks, optionally scaling that data to a consistent scale in the adapter before reverting it back to the scale in the ViT. The adapter may use group normalization instead of back normalization, and may comprise any other suitable pre or post processing. The adapter is trained at the same time as a plurality of decoders, preferably implementing functions in different domains such as recognition/classification, image generation, and text generation, and any other suitable function that may be considered an archetype for a subsequent desired function, and/or tasks that comprise image-level, region-level, and/or pixel-level perception.

Meanwhile, the ViT may be any suitable ViT.

In stage 2, both the ViT and the adapter are now fixed, and decoders that have already been trained may optionally be fixed or may still be trainable (e.g. for task specific fine tuning), or new decoders may be trained on the output of the frozen VFM.

It will be appreciated that in some embodiments the methods and techniques herein provide for efficient model training, as only the adapter of the VFM backbone is trained in stage 1 in conjunction with a core suite of decoders; whilst new tasks or applications simply require the training of a new decoder or the refinement of an existing one during stage 2.

Similarly advantageously, the modular approach makes the VFM scalable to a wide range of new tasks or applications, without risking knowledge collapse or behavior drift within the VFM itself.

The model itself can be relatively compact, in the order of 100 million parameters (although it is not limited to such and may be higher or lower), in part because of its modular nature. Consequently it is particularly suited to so-called edge or IoT use cases where a specific task can be implemented using the backbone and a suitable decoder in a compact fashion.

Because the model is modular, the backbone is easy to manage, maintain, and store rather than having different trained ViTs for different tasks.

Furthermore, because the adapter in particular is trained on a diverse set of tasks in conjunction with a plurality of decoders, the VLM is proficient in a wide range of use cases and applications, and also proficient at providing data labels for many such tasks.

### Variants

The VFMs as described herein may be deployed for example as a cloud service, for example to train a decoder for a specific required task—or optionally to train or fine tune an adapter if a suite of decoders is needed, or there is an issue with a decoder's performance. The finalised VFM may then either operate within the cloud on data sent to it, or be deployed to a point of need.

Alternatively or in addition the VFM could be provided locally, for example as a Docker® image. The identity and/or integrity of the ViT and the adapter could optionally be confirmed with hashes or similar cryptographic signatures reported to an authentication server for such deployments.

As noted previously, the VFM could be baked into an edge application, for example on an IoT device, alongside a single decoder (or a subset thereof) to perform one or a limited range of specific tasks locally, thereby reducing the need for robust and continuous high volume data communication to a cloud server for the decoder function. Also as noted previously, because the ViT, adapter, and decoder can be comparatively small in this architecture, the computational and power overheads for the IoT device are manageable. Again the identity and/or integrity of the VFM or any of its components could optionally be confirmed with hashes or similar reported to an authentication server.

### SUMMARY

Embodiments of the present description use a trainable adapter in conjunction with a fixed ViT to build a VFM using multi-task learning, and propose several features of the adapter that enable or improve this process. Given the VFM, embodiments of the present description use a two-stage training pipeline to produce a generalized backbone and modular decoder scheme that enables a range of tasks to be scaled up without creating task conflicts in the backbone model. In the first stage the adapter is trained in conjunction with multiple decoders, typically for core vision tasks, to develop a generalized representation useful to diverse applications. In the second stage, for new decoders for new tasks, or for fine tuning of existing decoders for new/variant tasks, the adapter is also fixed, so that the backbone as a whole is fixed/frozen.

It will be appreciated that in practice if the ViT and/or the adapter were unlocked, either with a training update rate that was so small as to have a negligible effect, and/or only partially (e.g. a small subset of weights/parameters) that had a negligible effect, then optionally the backbone (or their respective parts thereof) can still be treated as effectively frozen. Hence references herein to ‘frozen’ or ‘fixed’ may optionally mean effectively/functionally frozen or fixed, ignoring de minimis modifications to make either component ‘not frozen’ or ‘not fixed’ as a technicality.

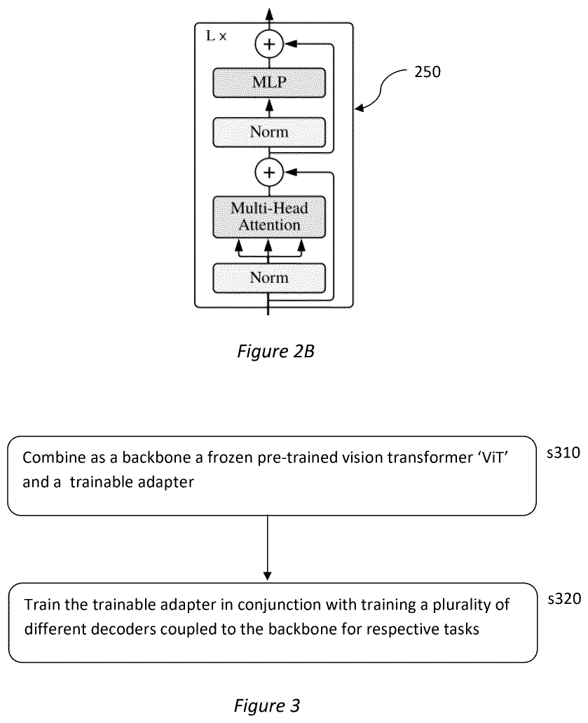

Referring now to FIG. 3, in a summary embodiment of the present description, a method of generating a vision foundation model ‘VFM’ comprises the following steps:
In a first step s310, combining as a backbone a frozen pre-trained vision transformer ‘ViT’ and a trainable adapter that is configured to interact with tokens of the ViT for successive interaction blocks of the ViT, by use of an injector and extractor, as described elsewhere herein; and
In a second step s320, training the trainable adapter in conjunction with training a plurality of different decoders comprising a first set of decoders, respectively coupled to the backbone for respective tasks, to produce the completed vision foundation model based on multi-task learning, as described elsewhere herein;
wherein the trainable adapter is configured to generate an output for the backbone for passing as input to a decoder, as described elsewhere herein.

It will be apparent to a person skilled in the art that variations in the above method corresponding to operation of the various embodiments of the apparatus as described and claimed herein are considered within the scope of the present invention, including but not limited to that the method comprises fixing the parameters of the backbone of the completed vision foundation model (including the trained adapter as well as the pre-trained ViT), and training a decoder to perform the specific task whilst the parameters of the backbone remain fixed, as described elsewhere herein.

It will be appreciated that the methods and techniques disclosed herein may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary embodiment of the present description, a vision foundation model 100 or circuitry comprising such a model comprises the following:
A backbone 110 as described elsewhere herein, comprising:
   a frozen pre-trained vision transformer ‘ViT’ 112 as described elsewhere herein; and
   a trainable adapter 114 as described elsewhere herein, configured (for example by suitable software instruction) to interact with tokens of the ViT for successive interaction blocks 240 of the ViT, by use of an injector 220 and extractor 230.
The trainable adapter is configured (for example by suitable software instruction) to generate an output for the backbone (e.g. via projection module 260) for passing as input to a decoder 116.
The trainable adapter 114 is trained in conjunction with training a plurality of different decoders 116 comprising a first set of decoders, respectively coupled to the backbone 110 for respective tasks, to produce the completed vision foundation model (e.g. the backbone, optionally with a suite of one or more decoders) based on multi-task learning (the tasks of the different decoders trained alongside the adapter).

The schedule of training for the decoders when in conjunction with training the adapter may be any suitable schedule. For example, for N decoders, each could be trained for 1/Nth of a training epoch of the adapter, the adapter itself having M training epochs. In this way the training/learning rates and convergence for both the adapter and the decoders can progress roughly in parallel.

Instances of this summary embodiment implementing the methods and techniques described herein (for example by use of suitable software instruction) are envisaged within the scope of the application, including but not limited to that:
the trainable adapter comprises a minority of the weights or parameters of the backbone, as described elsewhere herein;
   in this instance, optionally the trainable adapter comprises fewer than one or more selected from the list consisting of 40%, 30%, 20%, 15%, 10%, and 5% of the weights or parameters of the backbone;
the injector of the adapter scales the respective token norms of a given ViT block to a common scale prior to processing by the adapter, and reverses the scaling when returning values to the ViT, as described elsewhere herein. It will be appreciated that the scaling to a common scale (e.g. for token norms for the adapter) may constitute a scaling up or a scaling down, as required;
the extractor of the adapter scales the respective token norms of a given ViT block to a common scale prior to any further processing, as described elsewhere herein. Again the scaling to a common scale may constitute a scaling up or a scaling down, as required;
the adapter uses group normalization instead of batch normalization, as described elsewhere herein;
   in this instance, optionally the adapter uses group normalization instead of batch normalization for one or more selected from the list consisting of a spatial prior module of the adapter, and a projection module of the adapter, as described elsewhere herein;
the vision foundation model may comprise the frozen pre-trained ViT and the trained adapter, wherein the trained adapter is also frozen, and one of the trained decoders of the first set of decoders (e.g. for subsequent inference tasks), as described elsewhere herein;
   in this instance, optionally the trained decoder is fine-tuned (e.g. further trained) to a specific task whilst the ViT and adapter remain frozen, as described elsewhere herein; and
the vision foundation model may comprise the backbone comprising the frozen pre-trained ViT and the trained adapter, wherein the trained adapter is also frozen, and a new decoder for a specific task (e.g. a task not already supported by an existing decoder), wherein the new decoder is trained for the specific task whilst the ViT and adapter remain frozen, as described elsewhere herein.

The vision foundation model may be incorporated into any suitable vision application or circuitry comprising such an application, again typically with the ViT and trained adapter frozen, and at least a first trained decoder for the function(s) required by the application. The vision application itself may for example be standalone, part of a suite of applications, or a middleware function used to assist with the creation of a further software project. One or both of the vision foundation model and the vision application may exist in a run-time state (e.g. in suitable working memory) or as non-transitory, computer readable storage media containing a computer program comprising computer executable instructions that when executed by a computer system give rise to the vision foundation model and/or the vision application.

Optionally the application may be configured to compute a fingerprint (e.g. a hash or other cryptographic derivation as described elsewhere herein) of at least one component of the vision foundation model, such as the ViT, adapter, and/or decoder, and is then configured to pass the fingerprint to an authentication system (whether local or on a remote server). Optionally, the application is configured to then only use the vision foundation model if it is confirmed by the authentication system (e.g. there is a fingerprint match).

In any case in turn such an application or circuitry therefor may be embedded within a device, such as an IoT device comprising an input operable to receive image data (e.g. a camera, or a data feed to receive live or recorded images from elsewhere), and a processor operable to execute the vision application, which may then perform its function(s) on the image data. The device then also comprises an output operable to provide data from the vision application for subsequent use, whether that use is internal to the device, or reporting to a further local or remote device.

In a further summary embodiment of the present description, a server is configured:
To receive a first request for a backbone comprising both of a ViT and an adapter from a set of differently trained adapters, the request including identification information for first tasks according to which each of the set of adapters have been trained; hence for example the request enables a choice of backbone according to task requirements, for example to apply to an image sensor, as described elsewhere herein;
To provide via interface circuitry, the backbone; hence for example this may be provided on the server side, or downloaded to a requesting client, as described elsewhere herein;
To receive a second request for a decoder adapted to perform a second task when appended to the backbone; hence for example enabling a choice of the task to update the backbone with, as described elsewhere herein.
And to provide, via the interface circuitry the decoder adapted to perform a second task, as described elsewhere herein; again, for example this may be provided on the server side, or downloaded to a requesting client.

It will be appreciated that the first request and/or the second request may comprise either single or multiple tasks, for example as a compound task, or a set of tasks that may be performed in series or parallel as appropriate and optionally as indicated by the relevant request(s), and so the first task and second task may comprise such combinations of tasks.

Similarly, if a task or set of tasks requires more than one decoder, then more than one decoder may be provided.

It will also be appreciated that the first request and second request may take the form of a combined request for or corresponding to a particular configuration of backbone and decoder(s), and similarly provision of the backbone and decoder(s) may be combined.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present description may be defined as described elsewhere herein and in accordance with the following numbered clauses:

Clause 1. Circuitry comprising a vision foundation model, comprising:
a backbone, comprising:
   a frozen pre-trained vision transformer ‘ViT’; and
   a trainable adapter configured to interact with tokens of the ViT for successive interaction blocks of the ViT, by use of an injector and extractor;
   the trainable adapter configured to generate an output for the backbone for passing as input to a decoder;
   and wherein
the trainable adapter is trained in conjunction with training a plurality of different decoders comprising a first set of decoders, respectively coupled to the backbone for respective tasks, to produce the completed vision foundation model based on multi-task learning.

Clause 2. The circuitry of clause 1, in which
the trainable adapter comprises a minority of the weights or parameters of the backbone.

Clause 3. The vision foundation model of clause 1 or 2, in which
the trainable adapter comprises fewer than one or more selected from the list consisting of:
   i. 40%;
   ii. 30%;
   iii. 20%;
   iv. 15%;
   v. 10%; and
   vi. 5%
of the weights or parameters of the backbone.

Clause 4. The circuitry of any preceding clause, in which:
the injector of the adapter scales the respective token norms of a given ViT block to a common scale prior to processing by the adapter, and reverses the scaling when returning values to the ViT.

Clause 5. The circuitry of any preceding clause, in which:
the extractor of the adapter scales the respective token norms of a given ViT block to a common scale prior to any further processing.

Clause 6. The circuitry of any preceding clause, in which:
the adapter uses group normalization instead of batch normalization.

Clause 7. The circuitry of clause 6, in which:
the adapter uses group normalization instead of batch normalization for one or more selected from the list consisting of:
   i. a spatial prior module of the adapter; and
   ii. a projection module of the adapter.

Clause 8. The circuitry of any preceding clause, comprising:
the backbone comprising the frozen pre-trained ViT and the trained adapter, wherein the trained adapter is also frozen; and
one of the trained decoders of the first set of decoders.

Clause 9. The circuitry of clause 8, wherein:
the trained decoder is fine-tuned to a specific task whilst the ViT and adapter remain frozen.

Clause 10. The circuitry of any preceding clause, comprising:
the backbone comprising the frozen pre-trained ViT and the trained adapter, wherein the trained adapter is also frozen; and
a new decoder for a specific task; wherein
the new decoder is trained for the specific task whilst the ViT and adapter remain frozen.

Clause 11. Circuitry comprising a vision application, comprising:
the circuitry of any preceding clause, wherein the ViT and trained adapter are frozen; and
at least a first trained decoder.

Clause 12. The circuitry of clause 11, in which
the vision application is configured to compute a fingerprint of at least one component of the vision foundation model;
the application is configured to pass the fingerprint to an authentication system; and
the application is configured to use the vision foundation model if it is confirmed by the authentication system.

Clause 13. A device operable to perform a vision task, comprising:
an input operable to receive image data;
a processor configured to execute the vision application of clause 11 or clause 12; and
an output operable to provide data from the vision application for subsequent use.

Clause 14. A method of generating a vision foundation model, comprising the steps of:
combining as a backbone a frozen pre-trained vision transformer ‘ViT’ and a trainable adapter configured to interact with tokens of the ViT for successive interaction blocks of the ViT, by use of an injector and extractor;
training the trainable adapter in conjunction with training a plurality of different decoders comprising a first set of decoders, respectively coupled to the backbone for respective tasks, to produce the completed vision foundation model based on multi-task learning; wherein
the trainable adapter is configured to generate an output for the backbone for passing as input to a decoder.

Clause 15. A method of generating a task-specific vision model, comprising:
fixing the parameters of the backbone of the completed vision foundation model of clause 14, including the trained adapter as well as the pre-trained ViT; and
training a decoder to perform the specific task whilst the parameters of the backbone remain fixed.

Clause 16. A non-transitory, computer readable storage medium containing a computer program comprising computer executable instructions that when executed by a computer system, cause the computer system to perform the method of any of clauses 14 or 15.

Clause 17. A server configured to:
receive a first request for a backbone comprising both of a vision transformer ‘ViT’ and an adapter from a set of differently trained adapters, the request including identification information for first tasks according to which each of the set of adapters have been trained;
provide via interface circuitry, the backbone;
receive a second request for a decoder adapted to perform a second task when appended to the backbone;
provide, via the interface circuitry the decoder adapted to perform a second task.

1. Circuitry comprising a vision foundation model, comprising:
a backbone, comprising:
a frozen pre-trained vision transformer ‘ViT’; and
a trainable adapter configured to interact with tokens of the ViT for successive interaction blocks of the ViT, by use of an injector and extractor;
the trainable adapter configured to generate an output for the backbone for passing as input to a decoder;
and wherein
the trainable adapter is trained in conjunction with training a plurality of different decoders comprising a first set of decoders, respectively coupled to the backbone for respective tasks, to produce the completed vision foundation model based on multi-task learning.

2. The circuitry of claim 1, in which
the trainable adapter comprises a minority of the weights or parameters of the backbone.

3. The vision foundation model of claim 2, in which
the trainable adapter comprises fewer than one or more selected from the list consisting of:
i. 40%;
ii. 30%;
iii. 20%;
iv. 15%;
v. 10%; and
vi. 5%
of the weights or parameters of the backbone.

4. The circuitry of claim 1, in which:
the injector of the adapter scales the respective token norms of a given ViT block to a common scale prior to processing by the adapter, and reverses the scaling when returning values to the ViT.

5. The circuitry of claim 1, in which:
the extractor of the adapter scales the respective token norms of a given ViT block to a common scale prior to any further processing.

6. The circuitry of claim 1, in which:
the adapter uses group normalization instead of batch normalization.

7. The circuitry of claim 6, in which:
the adapter uses group normalization instead of batch normalization for one or more selected from the list consisting of:
i. a spatial prior module of the adapter; and
ii. a projection module of the adapter.

8. The circuitry of claim 1, comprising:
the backbone comprising the frozen pre-trained ViT and the trained adapter, wherein the trained adapter is also frozen; and
one of the trained decoders of the first set of decoders.

9. The circuitry of claim 8, wherein:
the trained decoder is fine-tuned to a specific task whilst the ViT and adapter remain frozen.

10. The circuitry of claim 1, comprising:
the backbone comprising the frozen pre-trained ViT and the trained adapter, wherein the trained adapter is also frozen; and
a new decoder for a specific task; wherein
the new decoder is trained for the specific task whilst the ViT and adapter remain frozen.

11. Circuitry comprising a vision application, comprising:
the circuitry of claim 1, wherein the ViT and trained adapter are frozen; and
at least a first trained decoder.

12. The circuitry of claim 11, in which
the vision application is configured to compute a fingerprint of at least one component of the vision foundation model;
the application is configured to pass the fingerprint to an authentication system; and
the application is configured to use the vision foundation model if it is confirmed by the authentication system.

13. A device operable to perform a vision task, comprising:
an input operable to receive image data;
a processor configured to execute the vision application of claim 11; and
an output operable to provide data from the vision application for subsequent use.

14. A method of generating a vision foundation model, comprising the steps of:
combining as a backbone a frozen pre-trained vision transformer ‘ViT’ and a trainable adapter configured to interact with tokens of the ViT for successive interaction blocks of the ViT, by use of an injector and extractor;
training the trainable adapter in conjunction with training a plurality of different decoders comprising a first set of decoders, respectively coupled to the backbone for respective tasks, to produce the completed vision foundation model based on multi-task learning; wherein
the trainable adapter is configured to generate an output for the backbone for passing as input to a decoder.

15. A method of generating a task-specific vision model, comprising:
fixing the parameters of the backbone of the completed vision foundation model of claim 14, including the trained adapter as well as the pre-trained ViT; and
training a decoder to perform the specific task whilst the parameters of the backbone remain fixed.

16. A non-transitory, computer readable storage medium containing a computer program comprising computer executable instructions that when executed by a computer system, cause the computer system to perform the method of claim 1.

17. A server configured to:
receive a first request for a backbone comprising both of a vision transformer ‘ViT’ and an adapter from a set of differently trained adapters, the request including identification information for first tasks according to which each of the set of adapters have been trained;
provide via interface circuitry, the backbone;
receive a second request for a decoder adapted to perform a second task when appended to the backbone;
provide, via the interface circuitry the decoder adapted to perform a second task.
